(19) United States
(12) Patent Application Publication
(10) Pub. No.: US 2019/0116239 A1
(43) Pub. Date: Apr. 18, 2019

(54) SYSTEM AND METHOD FOR CONTENT DELIVERY ON MOBILE DEVICES

(71) Applicant: TUBE Incorporated, Chelmsford, MA (US)

(72) Inventors: Shantigram Jagannath, Chelmsford, MA (US); Harjot Singh Saluja, Nashua, NH (US); Sharmistha Chatterjee, Karnataka (IN); Minyan Shi, Bolton, MA (US); Robin Balyan, Nashua, NH (US); Mahender r. Korandla, Westford, MA (US)

(73) Assignee: TUBE Incorporated, Chelmsford, MA (US)

(21) Appl. No.: 16/164,027

(22) Filed: Oct. 18, 2018

Related U.S. Application Data
(60) Provisional application No. 62/573,920, filed on Oct. 18, 2017.

(51) Int. Cl. H04L 29/08; H04L 12/26

(52) U.S. Cl. CPC H04L 67/2847; H04W 88/16; H04L 43/0876

(57) ABSTRACT

According to various embodiments, disclosed herein is a system for delivering content to a plurality of subscriber mobile devices. The system includes Mobile Acceleration Client (MAC) that provides common services to third party mobile apps enabling app and mobile web acceleration. This background service interacts with a server side gateway, referred to herein as a Mobile Acceleration Gateway (MAG), which performs acceleration of connections and gathers intelligence about downloaded content through crowd sourcing. Intelligence in the MAG is used to identify the most popular content in apps and websites, as well as provide a cache for such content for improving server side efficiency in delivering such content.

### CROSS-REFERENCE TO RELATED APPLICATIONS

This application claims priority to provisional application 62/573,920, filed on Oct. 18, 2017, which is herein incorporated by reference in its entirety.

### TECHNICAL FIELD

The present invention relates generally to systems and methods related to systems and methods for content delivery on mobile devices and more particularly to a background client and server side gateway that accelerate connections and improve efficiency in delivering content.

### BACKGROUND OF THE INVENTION

The growth of mobile internet traffic has seen effective ways to increase mobile user engagement by using enhanced high-quality image/video/multimedia content, in-app messages, notifications, download links, and/or ads. Moreover, brands and retailers use intelligent user targeting (i.e. serving the right ads at the right moment), innovative rich-media ad creatives (i.e. using display, video ads) through mobile web/apps to increase sales, building customer relationships, and improve brand loyalty. This leads to increasing use of network bandwidth for downloading and rendering high quality content on devices.

Downloading internet resources poses a serious bottleneck on the network at times when the network load is high. Users need to wait for significant amounts of time to access the app/web content until all the links and references are downloaded and rendered on the app/websites to be visible, thereby degrading user experience. One of the performance optimization techniques applied to load internet resources is prefetching, where the content is downloaded in advance, stored in the device cache, and loaded within apps and websites when the user clicks the content. However, this technique provides for limited improvement when the network load is high.

As such, additional improvements are needed to provide a seamless user experience ensuring low network load on operator networks.

### SUMMARY OF THE INVENTION

According to various embodiments, a system for delivering content to a mobile device on one or more mobile networks is disclosed. The system includes an ad-server on the mobile device. The ad-server includes a mobile acceleration client (MAC) that is configured to pre-fetch cached web content or advertisements received from a mobile acceleration gateway (MAG) when the mobile device is being connected to wifi, on a cellular network, and/or being connected to a cellular network with available unused capacity.

According to various embodiments, a method for delivering content to a mobile device on one or more mobile networks is disclosed. The method includes configuring an ad-server on the mobile device to include a mobile acceleration client (MAC). The MAC is configured to pre-fetch cached web content or advertisements received from a mobile acceleration gateway (MAG) when the mobile device is being connected to wifi, on a cellular network, and/or being connected to a cellular network with available unused capacity.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1A is a diagram showing content/ad prefetch with a mobile acceleration client (MAC) and mobile acceleration gateway (MAG) according to an embodiment of the present invention;

FIG. 1B is a diagram further showing content/ad prefetch with a mobile acceleration client (MAC) and mobile acceleration gateway (MAG) according to an embodiment of the present invention;

FIG. 2A is flowchart showing a dynamically created ad campaign according to an embodiment of the present invention;

FIG. 2B is a flowchart showing pre-loadable content being configured according to an embodiment of the present invention;

FIG. 2C is a flowchart showing the MAC prefetching content recommended by the MAG according to an embodiment of the present invention;

FIG. 2D is a diagram showing an ad-server with the MAC as a standalone background service according to an embodiment of the present invention;

FIG. 2E is a diagram showing an ad-server software development kit (SDK) with the MAC integrated according to an embodiment of the present invention;

FIG. 3A is a flowchart showing content/ad prefetch during good cellular network or wifi according to an embodiment of the present invention;

FIG. 3B is a flowchart showing sponsored ad management on a device according to an embodiment of the present invention;

FIG. 3C is a diagram showing preloaded ad request according to an embodiment of the present invention;

FIG. 3D is a diagram showing preloaded popular content according to an embodiment of the present invention;

FIG. 4 is a diagram showing sponsored or nonsponsored prefetch ad history according to an embodiment of the present invention;

FIG. 5 is a diagram showing data rewards in prefetched sponsored ads according to an embodiment of the present invention;

FIG. 6 is a graph showing a mechanism of prefetching ads during good cellular network or wifi according to an embodiment of the present invention;

FIG. 7A is a diagram showing an ad-server integrated with the MAC as a standalone service according to an embodiment of the present invention;

FIG. 7B is a diagram showing an ad-server as a SDK integrated with 3^{rd} party apps or ad-network SDKs according to an embodiment of the present invention;

FIG. 8A is a diagram showing a multi-carrier cross platform device independent sponsored ad service according to an embodiment of the present invention;

FIG. 8B is a diagram showing accounting by a sponsored gateway according to an embodiment of the present invention;

FIG. 9 is a diagram showing network aware acceleration according to an embodiment of the present invention;

FIG. 10 is a diagram showing caching and predictive download of content according to an embodiment of the present invention; and

FIG. 11 is a diagram showing a network aware ad cache according to an embodiment of the present invention.

### DETAILED DESCRIPTION OF THE INVENTION

According to various embodiments, disclosed herein is a system and method for a mobile device standalone background service, referred to as a Mobile Acceleration Client (MAC), that provides common services to third party mobile apps enabling app and mobile web acceleration. This background service interacts with a server side gateway, referred to as a Mobile Acceleration Gateway (MAG), which performs acceleration of connections and gathers intelligence about downloaded content through crowd sourcing. Intelligence in the MAG is used to identify the most popular content in apps and websites, as well as provide a cache for such content for improving server side efficiency in delivering such content.

The MAC works with the MAG to pre-fetch popular content in the apps that subscribe to the service. The MAC may also extend the service for sponsored advertisements for registered mobile apps, significantly improving the speed of delivery of advertisements and content. Prefetching of advertisements and content may additionally be done at advantageous times, such as when the device is on wifi or when a cellular network is strong. The prefetched content is stored in a device cache and made available to be pulled when a mobile user launches an app. The MAC can be implemented as an SDK for third party mobile apps to register for the service, or may be implemented as a mobile app that launches a background service for all apps on the device. In either case, the system reduces the data cost to deliver a mobile ad, improves app acceleration, improve ad-displaying quality, and increases ad-click authenticity.

According to various embodiments, the system may generally operate as follows:

(1) The user of a device is presented with a selection page—either through an application or a website. On the selection page the user may select areas of interest and opt-in to view advertisements in exchange of incentives such as a reward.

(2) The MAC, which runs on the background, pre-fetches relevant advertisements and caches them on the device. The MAC essentially performs the function of an ad-server on the device.

(3) One in embodiment, an Ad-SDK is provided to applications and websites, who in turn embed the SDK inside their inventory. The Ad-SDK contacts the ad-server running in the background whenever there is an opportunity to show an ad to the user.

(4) The ad-server or MAC serves a locally cached advertisement to the user which is relevant to the user and aligns with the user's selection.

According to various embodiments, this disclosure encompasses an accelerated download system that can be used at the server and mobile client to minimize network delays for downloading videos, images, advertisements, multimedia content and other web resources. The most expensive leg of the network comprises the cellular network where the latency is the highest. The MAC and the MAG work together to reduce the number of interactive connection open/close on the cellular network and the number of DNS resolution calls on the cellular network by creating a tunnel that allows connections and IP resolution to be multiplexed on to a single connection between the MAC and the MAG.

There is an incremental cost to downloading a resource if that resource is not consumed by the end-user, in which case the download consumes both network bandwidth and the device resources but not useful for the user. The system includes crowd sourced intelligence to create a list of web resources for that brand and the likelihood of the resource being consumed by the end user. This crowd sourced intelligence is combined with the brand indication on the back-end of which resources have a high likelihood of being consumed by the end user. This list of resources with a probability of being consumed higher than a configurable threshold is provided to the MAC, which then pre-fetches these resources to make it readily available to the user when the user is browsing the brand's website.

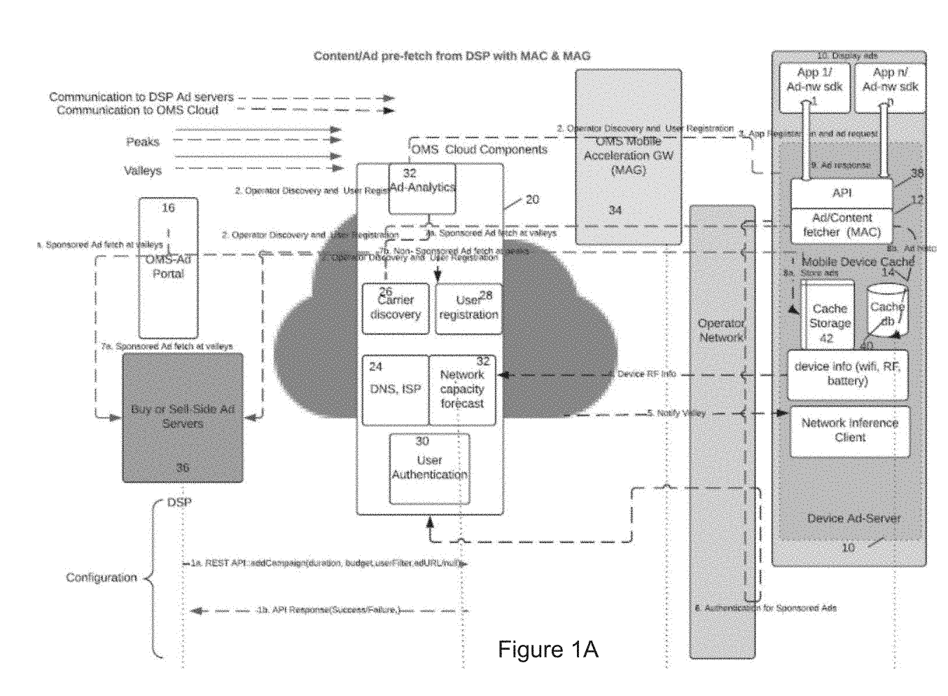

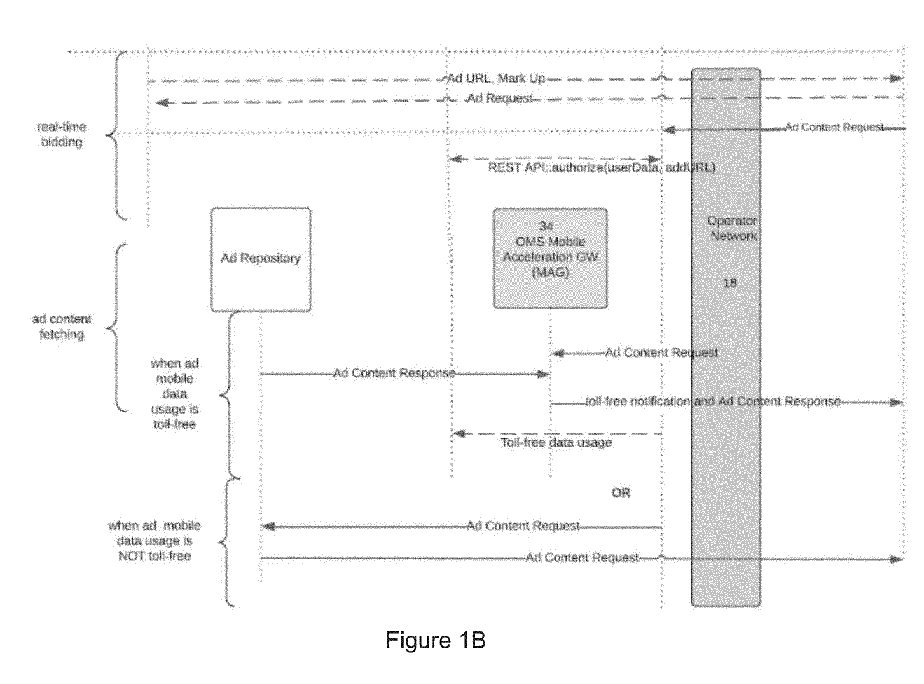

According to various embodiments, FIGS. 1A and 1B illustrate the overall system components. The system may include a device ad-server 10 with a built-in mobile acceleration client (MAC) 12 as a background service dedicated to serve individual subscribers and integrated 3^{rd} party applications' ad requests by updating a device cache 14. The device or mobile device may be implemented in a variety of configurations including general computing devices such as desktop computers, laptop computers, tablets, networks appliances, or mobile devices such as mobile phones, smart phones, or smart watches, as nonlimiting examples. The device includes one or more processors for performing specific functions and memory for storing those functions. The ad-server 10 can request ads on behalf of registered mobile applications or download a certain percentage of high-rated content/advertisements, which have a high likelihood of being consumed by the end user, when the device is on wifi or when network capacity is under-utilized. The device ad-server 10 will display the pre-fetched ads, notify the mobile user when an ad is sponsored or data reward is associated, and top-up the user's account if the user completes a desired action.

The ad-server 10 has intelligence to determine the number of ads to pre-fetch for a registered mobile application based on the mobile user's application user-behavior. For example, if a user uses a mobile application twice a day and visits three application pages on average with one interstitial ad and one video ad, the ad-server 10 will pre-fetch two ads of each type for this application in a day. The ad-server 10 preloads the cached ads for registered application, when the user launches the application, and the application requests an ad, irrespective of user-click. The ad-server 10 stores the cached ads when the mobile user powers off or re-boots the device, and restores the pre-fetched ads to cache when the device restarts. The ad-server 10 ensures the display of a pre-fetched, cached ad, and only display once so as not to break the number of impression analytics maintained by the demand side platform of the ad bidding, serving chain. The ad-server 10 can request sponsored ads or ads with data rewards from a backend DSP 36. Also, the backend DSP 36 can push data rewards to applications. The ad-server 10 interacts with the backend mobile data reward service to authenticate and authorize the mobile user for data reward ads of user's interests. The ad-server 10 will interact with backend mobile data reward service to top-up the user account for data rewarded when the user completes the action associated with the reward.

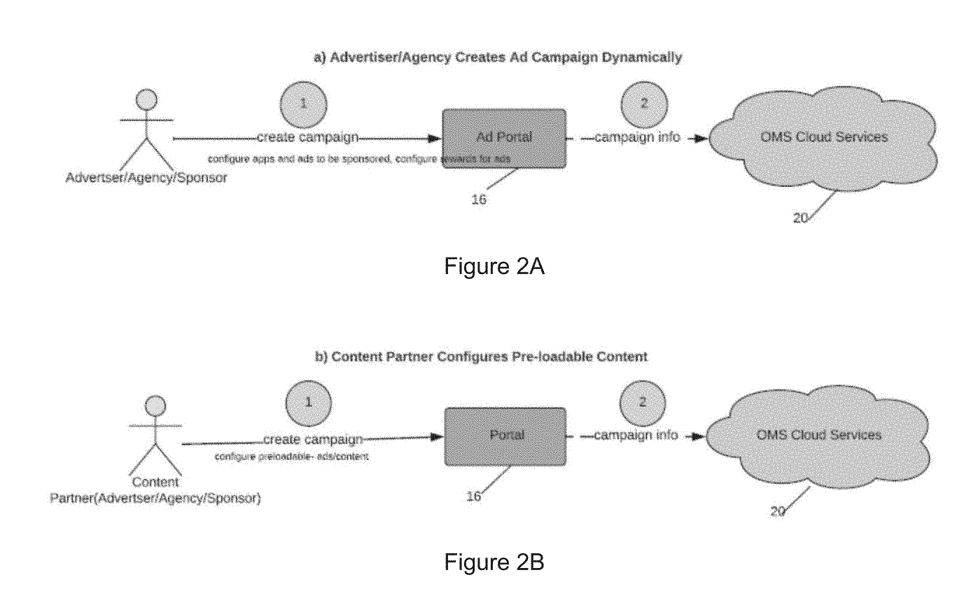

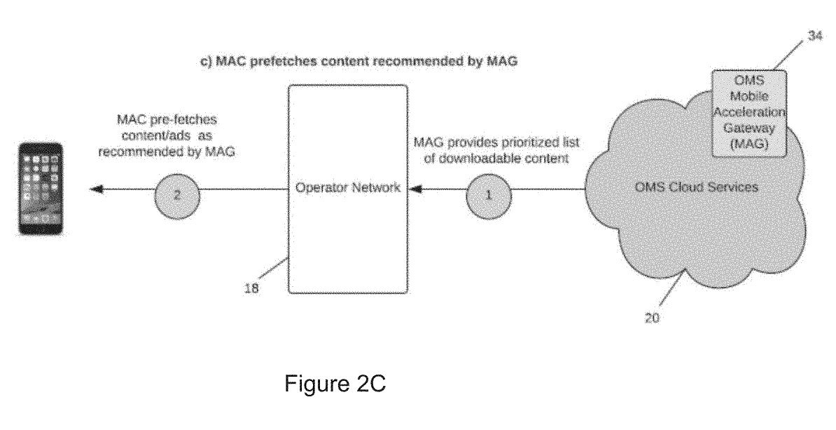

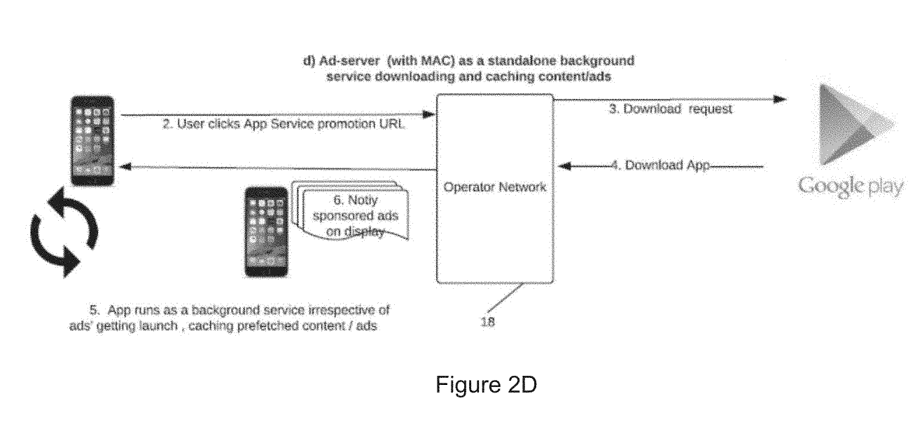

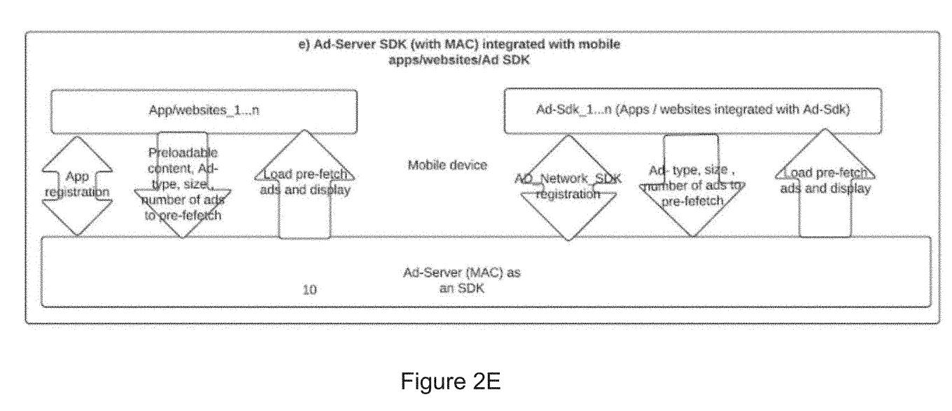

The system may further include a portal interface 16 to allow advertisers to sponsor advertisements on different operator networks 18 and to configure sponsored ad campaigns. The portal interface 16 further allows individual advertisers to configure ads to be sponsored or can be pushed into the subscriber devices during valley or when network capacity is high. The operator network 18 may be implemented as a single network or a combination of multiple networks. The operator network 18 may include but is not limited to wireless telecommunications networks, Zigbee, or other cellular communication networks involving 3G, 4G, 5G, and/or LTE. As illustrated by FIGS. 2A-2E, once onboard the portal interface 16, a sponsor can sponsor ad content on any operator network 18 that is configured for the ad-server 10. As illustrated in FIGS. 2A and 2B, the ad portal 16 is configured to allow one-time on boarding of advertisers. The ad portal 16 presents a user-interface to configure ads that can be sponsored by mobile apps. The content partner can configure ads and other pre-loadable content for easy download by the MAG 34. The ad portal 16 also provides flexibility to advertisers to create a campaign with data rewards or sponsored data for a targeted audience and allows advertisers to view the analytics.

The system may further include cloud components 20 such as such as a network capacity forecast module 22, an ISP (IP to network operator translator) module 24, a sponsored data discovery module 26, a sponsored user registration module 28, an authentication and authorization module 30, and a data analytics and data rewards module 32. The OMS cloud components 20 are responsible for service discovery, registration authentication, and authorization of any request for sponsored data by the device ad-server 10 for a specific operator deployment. The OMS cloud components 20 include a global carrier discovery module 26 which locates the carrier or operator network in respective countries. The OMS cloud components 20 include a user registration module 28 responsible for registering the user to sponsored ad services and generating UUID in a cellular network on being contacted by the ad services during its initialization phase. The OMS cloud components 20 include an authentication module 30 to authenticate each request made by the device ad-server 10 by matching application type, UUID, and/or ads sponsored with campaign configuration details. When contacted by the device ad-server 10, the authentication module 30 is responsible for authorizing a configured list of ads likely to be sponsored by the app in use on the mobile device. The OMS cloud components 20 include a network capacity forecast module 22 that is configured with an online learning algorithm to learn cell network capacity from crowd sourced RF data and notifies the device ad-server 10 at time of high network capacity, i.e., a valley. The OMS cloud components 20 include a domain name system and internet service provider module 24 responsible for redirecting sponsored ad traffic (ad download, share, view, buy, and/or sell) to load balanced gateway and re-validating the user's presence in a cellular network before sending sponsored ads, respectively. The OMS cloud components 20 includes ad-analytics 32 that maintains an accounting of sponsored ads and sponsored content fetched through the MAG 34 by each device per app level. The ad-analytics 32 holds statistics of pre-loaded content downloaded by the MAG 34 based on gateway recommendation, content partner recommendation, and/or mobile user's preference from apps or web sites.

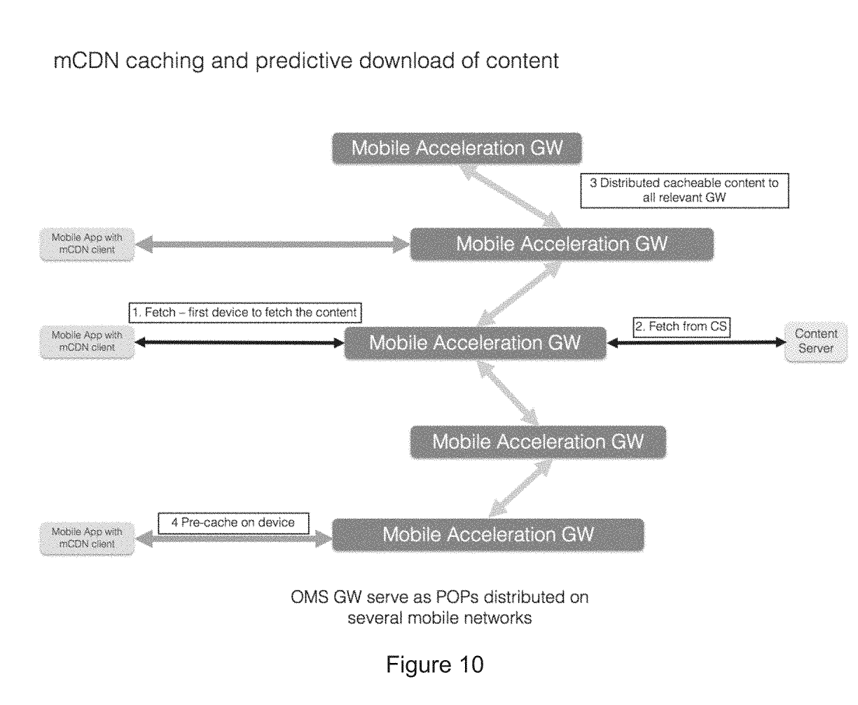

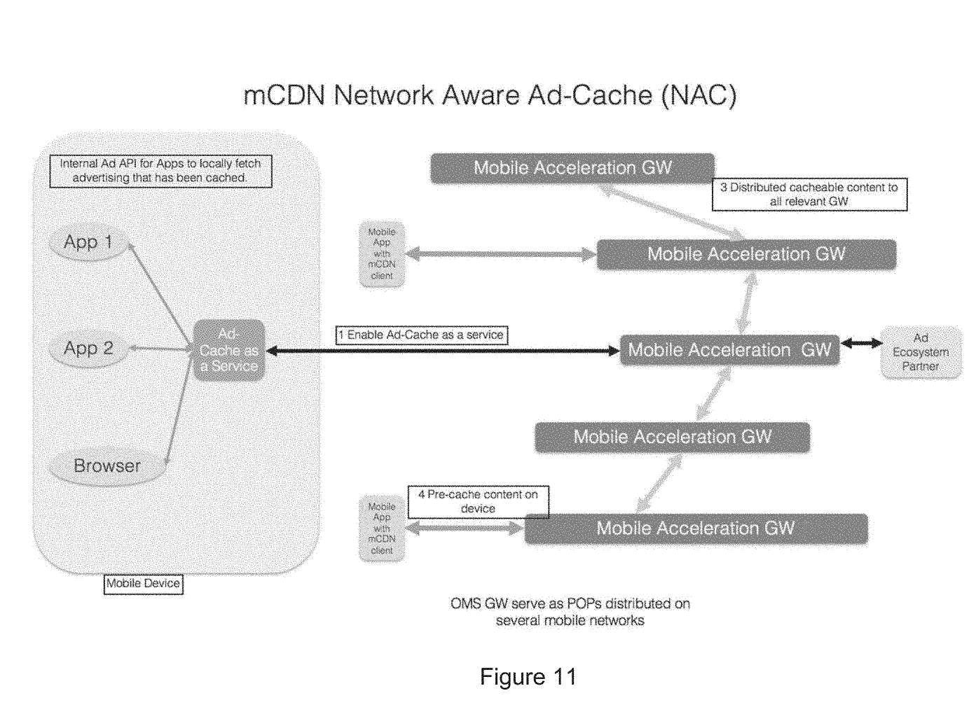

The system may further include a mobile acceleration gateway (MAG) 34 to pre-fetch and store content, which is then downloadable by the MAC 12. According to various embodiments, the MAG 34 is responsible for pre-fetching and caching user relevant advertisements and content from an ad-ecosystem partner (both in Wi-Fi and cellular network) by working in collaboration with content partners to integrate their API system to download pre-loadable content. This content is in turn is fetched/downloaded by the MAC 12, cached and pre-loaded by mobile clients in the app. This is further illustrated in FIGS. 10 and 11.

The MAG 34 supports intelligent learning algorithms that learn popular content fetched by apps through crowd-sourcing. The MAG 34 then creates a list of content prioritized by popularity that can be fetched by the MAC 12, known as a cache target list (CTL). The MAG 34 can also cache the pre-fetched content.

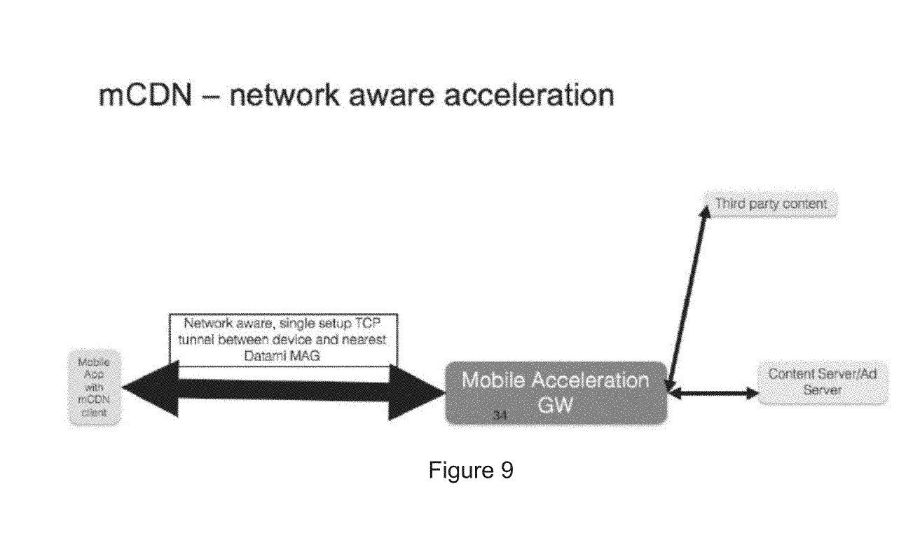

As shown in FIG. 9, the MAG 34 can be configured to accelerate the download of pre-loadable content to the MAC 12 by enabling one of more of the following.

(1) Robust tunneling, such as but not limited to a VPN or a persistent http tunnel, between the MAC 12 and the MAG 34 where a single connection is set up over which all resources are downloaded.

(2) Efficient compression techniques and network aware algorithms that are not compressed by brands.

(3) TCP tuning by controlling TCP window size.

(4) Downloading content that is already compressed by brands.

As the cloud components are deployed regionally across the globe, the MAG 34 which is nearest to the device can download the content from a content server 36, cache the content, and serve the content to the device via the MAC 12 during good network conditions or in Wi-Fi.

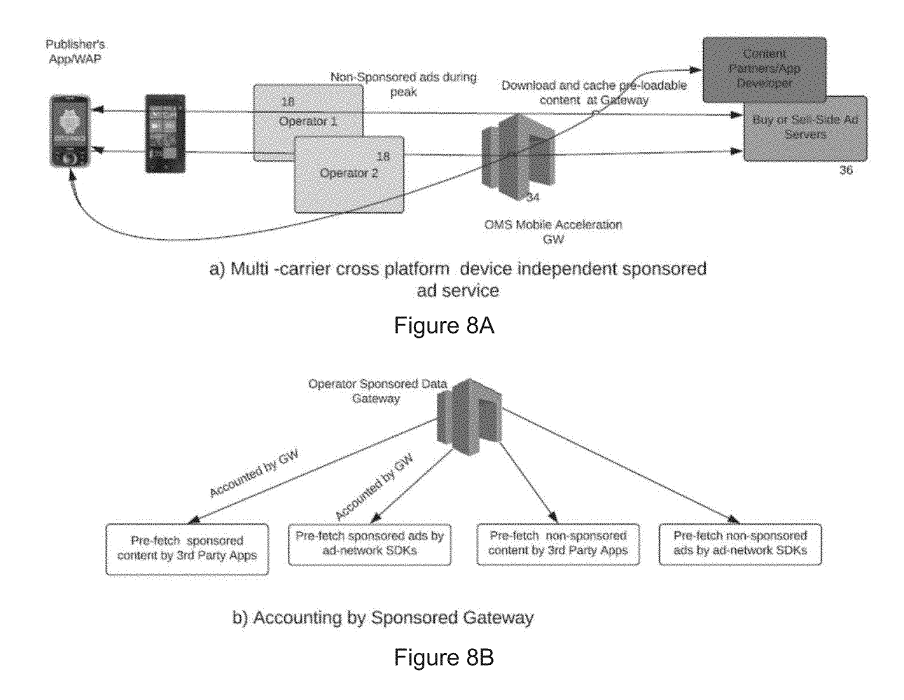

The MAG 34 works as an efficient scheduler to schedule the download of suitable content from the content partner to itself (based on configured campaign, rating and popularity of the content), cache it and then trigger download to the device by receiving notifications of the network conditions from network capacity forecast module, as shown in FIGS. 10 and 11. In addition, if any mobile data of the ad, application, or specific content is sponsored, the traffic is passed through the MAG 34 as shown in FIGS. 8A and 8B. The Mobile Acceleration Gateway generates sponsored data record for sponsored data traffic.

The ad-server 10 communicates with different demand side platform (DSP) ad-servers 36 to fetch targeted advertisements and OMS cloud components 20 to access sponsored ad content. The DSP 36 allows sponsors, such as content partners, advertisers, and/or app developers, to register ads for their specific apps through the ad portal 16. The ad portal 16 allows different sponsorship campaigns to be turned on or off by sponsors to target different ads to different user segments at period of lower network utilization.

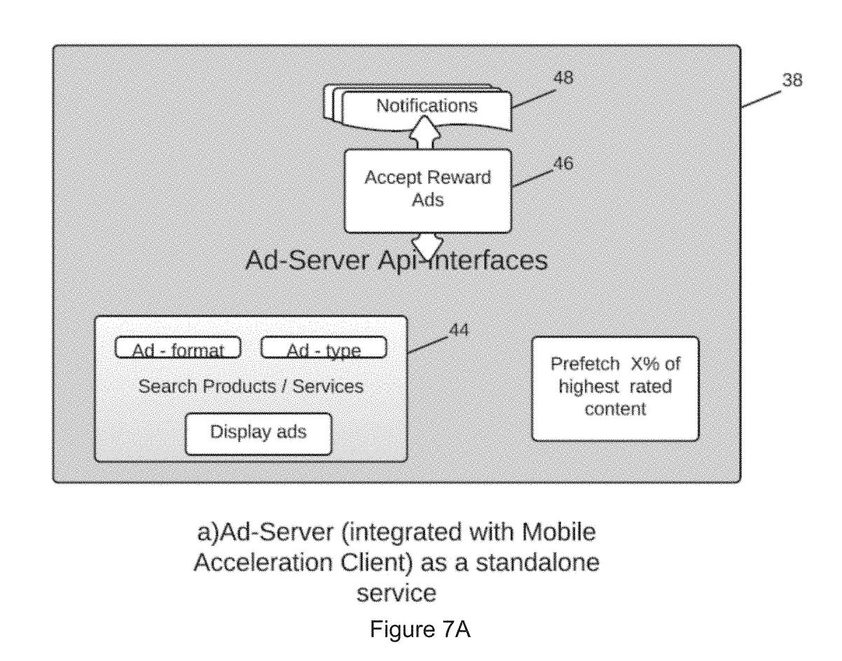

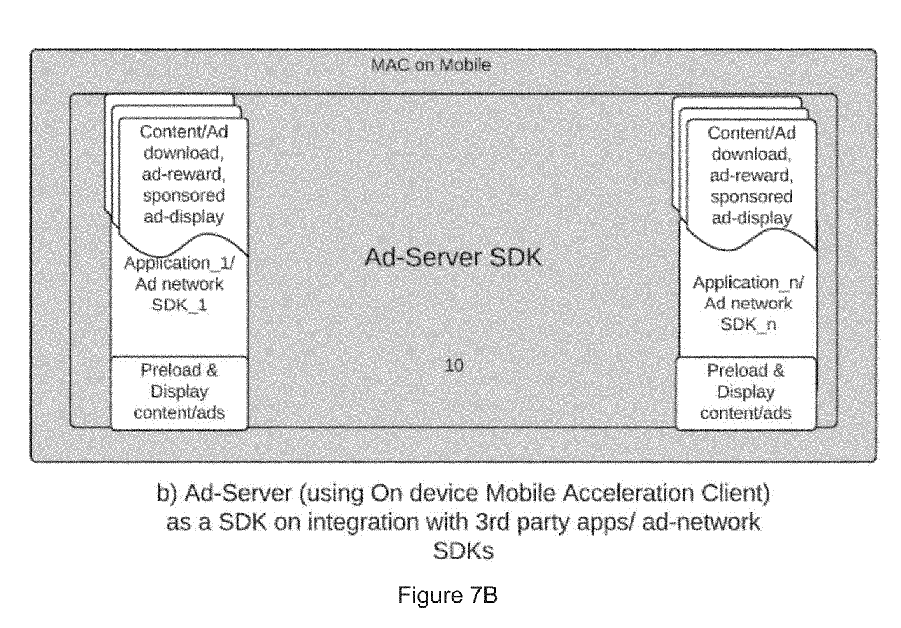

The device ad-server 10 can run as a single service at the device level to serve all registered apps/websites/SDKs. The device ad-server 10 can be configured as a standalone client to be downloaded from an app store or mobile campaign services. This is illustrated in FIG. 2D and FIG. 7A. The device ad-server 10 can also be configured as an SDK integrated with mobile apps or websites. This is illustrated in FIG. 2E and FIG. 7B. The device ad-server 10 runs independently as a background service regardless of whether a 3^{rd} party app is launched. As an SDK integrated with 3rd party apps or ad-network SDKs, the ad-server 10 allows integration with an API 38 to allow app subscription to the service to pre-fetch requested ads (along with ad format, ad type) and serving the ads to the apps on their behalf.

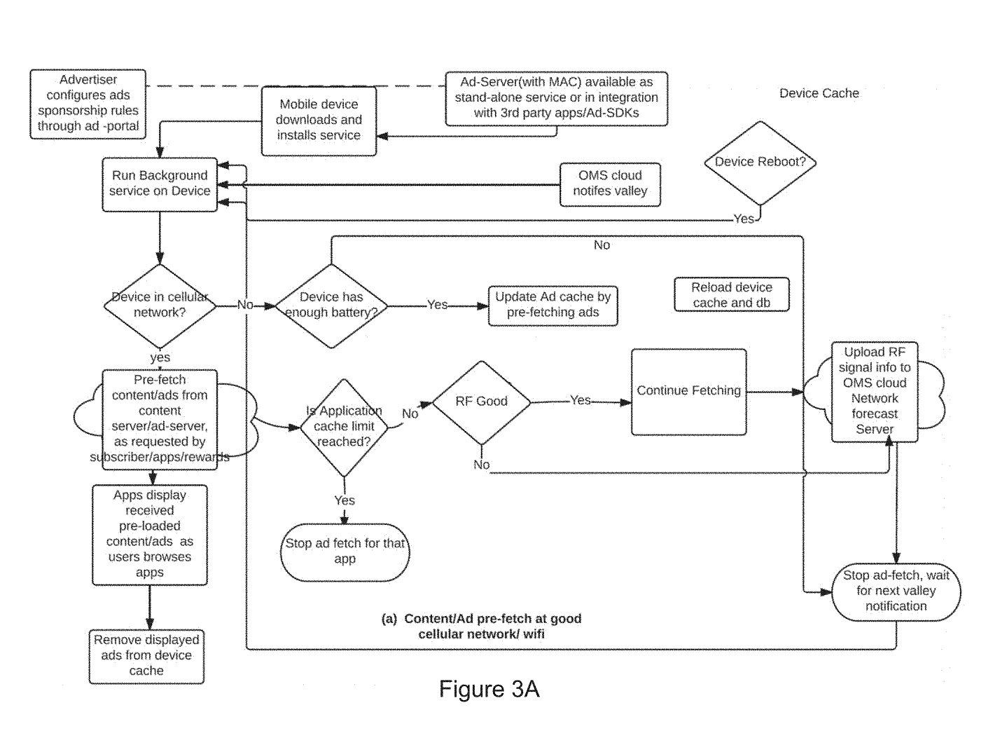

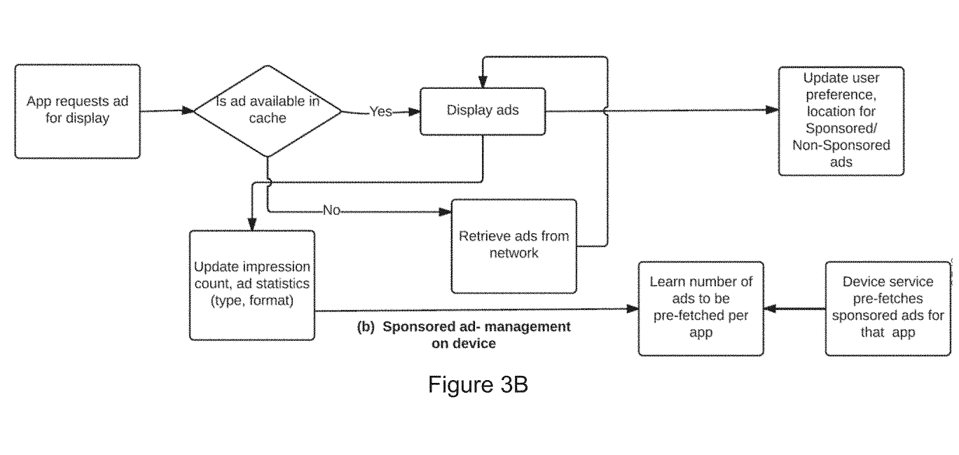

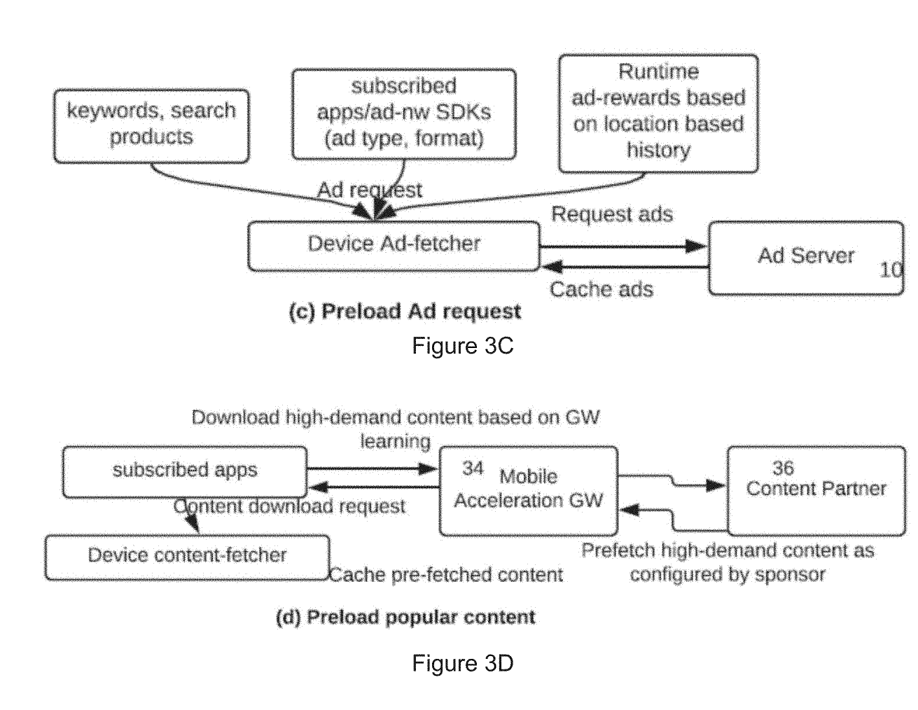

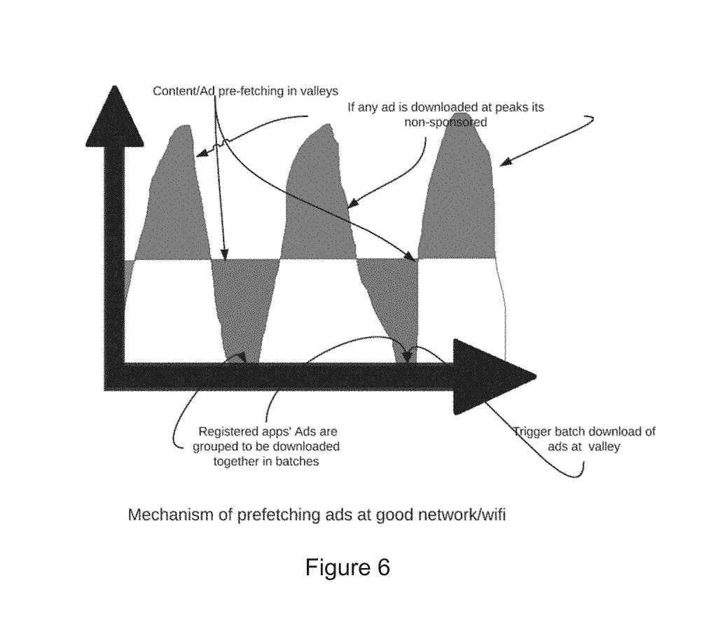

As illustrated by FIGS. 3A-3D, the MAC 12 on the device ad-server 10 is notified of the presence of higher network throughput from the network capacity module 22 that determines peaks and/or valleys of a cell from crowd-sourced RF data. The MAC 12 can prefetch the ads when the device is in wifi or the network capacity usage is low. The MAC 12 can prefetch the ads for all registered apps at once to save battery usage, based on remaining battery level of the mobile device. This is further illustrated in FIG. 6. The MAC 12 builds intelligence and reports to the MAG 34 on how the mobile device user uses the app and desires how many ads should pre-fetched in a time period, based on user's browsing characteristics of the app at the current location. The MAC 12 may run as part of the device ad-server 10 or can be integrated with an SDK that works with mobile apps or ads from ad networks providing them with the API 38 to pre-fetch, cache, preload, and accelerate content display.

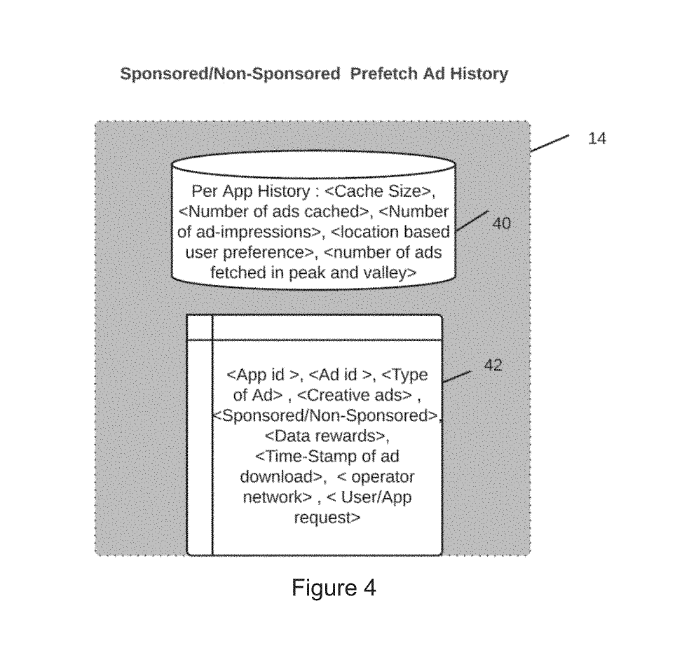

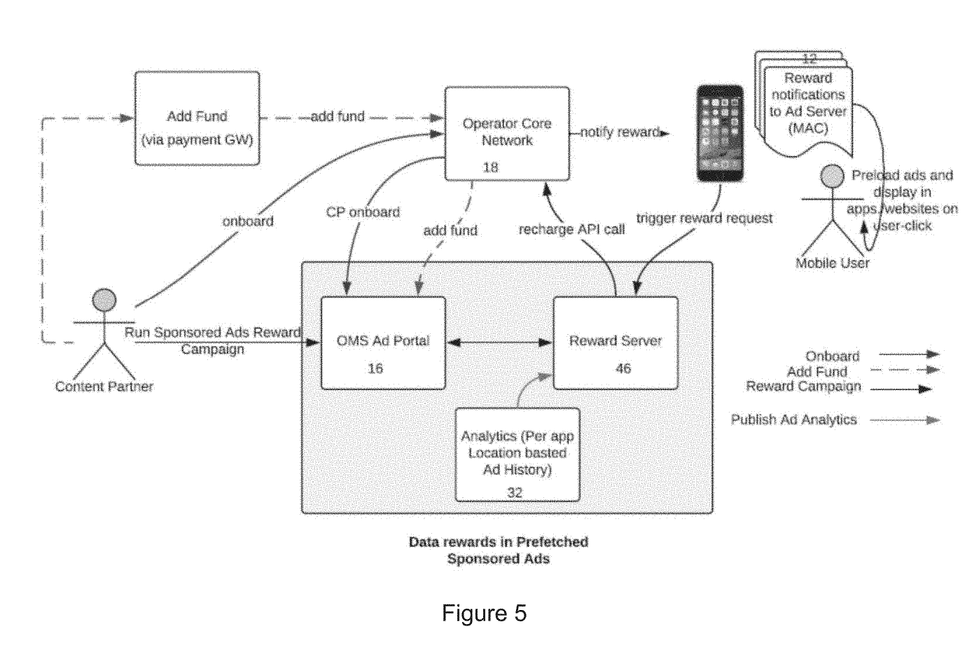

The MAC 12 uses a cache target list (CTL) shared by the MAG 34 to pre-fetch content from the MAG 34 which have a high likelihood of being consumed by the end user. The MAC 12 preserves impressions and click tracking by caching ads in cache storage 42 that have not been displayed yet. The ads displayed to the user once expire immediately. To display the same ads in future, the app communicates with the ad-service 10 to pre-fetch ads again. The device ad-server 10 maintains a database 40 that contains details like per application caching limit, ads cached based on user movements, and type of ads pre-fetched. The mobile device cache 14 containing the cache database 40 and cache storage 42 is further illustrated in FIG. 4. The device cache 14 stores the cached ads when the mobile user powers off or re-boots the device and restores the pre-fetched ads to cache when the device restarts. Ads or web content obtained through rewards, promotions, and/or offers may also be prefetched and cached in the device. This is further illustrated in FIG. 5.

The device cache 14 provides cross and multi operator support by storing cached items at the device cache storage 14. This is further illustrated in FIG. 8A. The MAC 12 running on the ad-server 10 being integrated with any ad SDK or 3rd party app can configure the device cache 14 at a specific directory on the device for any operator 18. This location specifies where ads can be stored in operator network 18. The device cache 14 works seamlessly with single or multiple SIMs, when the user roams across networks and migrates from one SIM to another or uses all SIMs at the same time.

The pre-fetched ads will be displayed by the mobile device as apps wake up when being used. The MAC 12 on the ad-server 10 is equipped with a configuration limit to download a certain percentage of most popular content through the MAG 34. Prefetching is linked with user specified ad formats if available; otherwise, prefetching includes all available ad formats as requested by the app. This is further illustrated in FIG. 2C. The ad-server 10 caches a pre-fetched ad with a flag to indicate the ad was sponsored or data rewards is associated with the ad. The sponsored flag is set if the ad is downloaded as sponsored ad.

FIG. 7A shows the ad-server API 38 when the ad-server 10 is running as a standalone service. The API 38 includes a user interface 44 to allow users to enter preferred products and services. The options include specification of ad formats like banner ads, interstitial (full screen) ads, interactive ads and customized search ads. For apps or websites integrated with an Ad-SDK, the API 38 includes a rewards user-interface 46 to accept ad rewards for viewing, purchasing, selling, and/or sharing ads. The API 38 also includes a notification module 48 to receive notifications of ad pre-fetch complete, whether the ad data usage is sponsored, and whether a data reward is associated with the ad. The user interface 44 allows a mobile user to input products or services keywords related to ads a user wishes to see. The MAC 12 uses the keyword information when requesting an ad to facilitate content download.

According to various embodiments, as illustrated in FIG. 7B, the SDK includes a programming interface to allow a third-party mobile application to register and to submit the ad creative (ad type, frame size) to be supported by the same third-party mobile application. The background service or SDK can detect if a device is on wife or if the device is being charged as well as being able to receive a network capacity under-utilized notification from the cloud components 20.

According to various embodiments, the ad-server 10 is responsible for initiating a call to Global Discovery Service with cellular MCC or MNC to locate the OMS gateway associated with the specific carrier deployment. In a non-cellular network, cached ads displayed by apps pass through the MAG 34 but are not accounted. This is further illustrated in FIGS. 8A-8B. In a cellular network, all requested from the MAC 12 contain unique device identification details (UUID) to identify a user's device and the application requesting it. The ad-server 10 may contain an authentication client which talks to the user authentication 30 to authorize users for sponsored ads or data rewards.

According to various embodiments, the system may include an ad analytics module 32 as part of the cloud components 20. The device ad-server 10 can send events to the ad analytics module 32 to learn one or more of the following: the number of ads being pre-fetched per app; statistics of popular ads fetched as listed by the MAG 34; statistics of sponsored ads or ads with data rewards; the number of pre-fetched ads being displayed per app; time duration during which the ad is cached before user views it; and the ratio of ads being served by the DSP during ad pre-fetch. The ad analytics 32 may also understand and analyze user-interest and behavior at any given time and location to fine-tune the timing and type of ads to pre-fetch.

According to various embodiments, the MAC 12 works with the MAG 34 by using collective content prefetching in the following manner. The MAC 12 and MAG 34 work together to reduce the number of connections that are setup by setting up a single connection over which all resources are downloaded in a much higher acceleration than normal download, in a similar manner to a VPN or a persistent http tunnel. Where applicable, the MAC 12 and MAG 34 work using compressed data, unless already compressed by the brand. The MAG 34 creates a brand partner specific list of resources, the CTL, which have a high likelihood of being consumed by the end user. The CTL is shared with the MAC 12. The MAC 12 pre-fetches these resources either on the cellular network to improve the perceived user experience and/or on a lower cost network (either on wifi or on underutilized time on the cellular network) to gain advantage on the cost of mobile data. As such, an instant delivery of content and advertisements provides a great user experience. Additionally, data rewards may be given to mobile user for viewing preloaded content or ads. Allowing a mobile user to choose advertising options based on a user's product and services interests, subject and theme interests, allows for the download of high demand content.

According to various embodiments, disclosed herein is an integrated client-server solution with mobile client incorporated in a device, intermediate server-side gateway, and back-end cloud components along with a 3rd party content server. The system may be implemented as a standalone application or as an SDK, to be either downloaded from an application store (such as Android, Windows, or IOS) or to be pushed into the mobile device by a network operator when there is unused capacity available in the network.

The following advantages and value are readily apparent from the system and methods described above. App and mobile web acceleration is provided by minimizing DNS resolution time and connection-setup time. The MAC and MAG work together to reduce the number of connections that are setup by setting up a single connection over which all resources are downloaded. The speed of delivering content to devices is enhanced through prefetch and preload. Mobile data charges are reduced by pre-fetching ads with sponsored mobile data use, or pre-fetch the most popular content when the user device is on wifi or when the network capacity is under-utilized. Ads may also be fetched to improve the user experience with no advantage on the cost using regularly priced mobile data.

Mobile ad displaying quality is improved by playing the ad from the cache on the mobile device. The cache can provide a shared memory for downloaded advertisements and/or popular, high-rated content across apps and browsers. IAB category filtering and ad prioritization are available per ad-ecosystem partner without any loss in functionality in order to provide the right ad to the right user. Displaying pre-loaded ads upon launch of an app can work with both private placement of ads and ad auctions. Ad clicking through rate and conversion rate is improved by requesting and/or downloading the most popular ads, sponsoring mobile ad data usage, and providing data reward incentives.

A learning algorithm is built-in to decide the number of ads to be pre-fetched for a mobile application during 24-hour period, reducing resource usage from over fetch and avoiding ad staleness. An intelligent downloader/ad-fetch module is included that downloads advertisements from the cellular network by effectively using radio resources during high network capacity. An intelligent learning algorithm at the MAG can rate content based on their popularity, demand, and usage statistics gathered through crowd-sourcing. The CTL can be cached at the MAG and downloaded by the MAC. An efficient transport mechanism is provided by enabling network-aware algorithms, TCP/UDP tuning, and/or text compression when content is cached through the MAG.

Easy, one-time integration with mobile apps is provided. As pre-fetched are directly linked to a user's preference or choice. The ad-server with MAC as a standalone background service or as an SDK integrated with an ad-network provides targeted location-based ads to end users, enabling them to use or download ads with minimal to no data cost. Apps are allowed to selectively choose and display ads when mobile subscribers use such apps, by fetching them from the network during periods of available network capacity.

A fast, easy to use, responsive user-interface allows subscribers to enter preferred ads at any given location. Sponsored ad-content can be embedded with its own visual style and presentation format based on device screen size and model.

A detailed per user and per app analytics, with details of pre-fetched content, based on types of sponsored advertisements being viewed at different times of available network capacity is available. Cost-efficient retargeting opportunities across several apps is thus increased. It also allows content partners to push the next relevant ad to the user. Ad-ecosystem analytics are accurate and verifiable, allowing the ad incidence to be verified by a third party even though the ad is delivered to the apps through the ad-cache service.

The system can work independently and seamlessly across cross-operator networks while mobile subscribers switch SIMs or roams across different networks. It's capable of running in dual-SIM or quadruple SIM devices as the cache works at device. The scalable, interoperable solution can be deployed in any operator network integrated with any ad-network or 3rd-party app. The system has no dependencies on carrier network and/or mobile device platform, make, or model.

The disclosed approach enables easy integration mechanism to diverse mobile platforms across multiple operator networks (3G, 4G, 5G, femto cell) to enhance accelerated content/ad pre-fetching and pre-loading improving end user experience. The mechanism prioritizes different categories of content and/or advertisements based on its usage statistics from crowd-sourcing to fetch them in advance in good network conditions or wifi at a higher connection speed so that they are pre-loaded by apps or ad-network websites and consumed by end users.

The system allows for an easy distribution strategy by distributing as a push model at the operator-end or a pull model by fetching the service at the subscriber end from an app store. Therefore, app monetization is ensured for ad-publishers or distributors and operators can effectively utilize the network by pushing this service during low network usage. As subscribers are provided with efficient techniques for using mobile radio resources and granted rewards during ad-downloading at times of low network usage, their data cost for viewing the ads or browsing content remains low. This acts as an added incentive for subscribers to use mobile data, since they can seamlessly browse content at a lower data cost. Additionally, brands also have an advantage of lower data cost in cases where the data is sponsored or the brand is paying for the data usage.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

What is claimed is:

1. A system for delivering content to a mobile device on one or more mobile networks, the system comprising:
an ad-server on the mobile device, the ad-server comprising a mobile acceleration client (MAC) configured to pre-fetch cached web content or advertisements received from a mobile acceleration gateway (MAG) when the mobile device is one or more of being connected to wifi, on a cellular network, and being connected to a cellular network with available unused capacity.

2. The system of claim 1, wherein the MAC is configured to run as a software development kit (SDK).

3. The system of claim 1, wherein the MAC is configured to run as a background module on the mobile device.

4. The system of claim 1, further comprising a portal interface configured to allow an advertiser to sponsor mobile data usage for one or more digital content on the one or more networks.

5. The system of claim 4, wherein the portal interface is further configured to allow an advertiser to push advertisements onto the mobile device when network capacity usage is low.

6. The system of claim 1, further comprising a network capacity forecast module on a cloud server, the network capacity forecast module configured to determine network capacity from crowd-sourced radio frequency data.

7. The system of claim 6, wherein the MAG is configured to cache the web content or advertisements in order to distribute to the mobile device through the MAC upon receipt of a notification of available unused network capacity from the network capacity forecast module.

8. The system of claim 1, wherein the MAC uses a cache target list (CTL) shared by the MAG to pre-fetch web content or advertisements from the MAG that have a higher likelihood of being consumed.

9. The system of claim 1, wherein the ad-server further comprises a device cache for storing the pre-fetched web content or advertisements.

10. The system of claim 1, wherein a request from the MAC contains a universally unique identifier (UUID) to identify the mobile device.

11. The system of claim 1, wherein the MAC and MAG are connected via a single connection comprising one or more of a VPN and http tunnel.

12. The system of claim 1, further comprising one or more MAGs, wherein the MAG closest to the mobile device is configured to download, cache, and distribute the web content or advertisements to the mobile device.

13. The system of claim 1, wherein the MAG is configured to schedule a download of the web content or advertisements based on one or more of a preconfigured campaign, a rating of the web content or advertisements, and popularity of the web content or advertisements.

14. A method for delivering content to a mobile device on one or more mobile networks, the method comprising:
configuring an ad-server on the mobile device to include a mobile acceleration client (MAC), the MAC configured to pre-fetch cached web content or advertisements received from a mobile acceleration gateway (MAG) when the mobile device is one or more of being connected to wifi, on a cellular network, and being connected to a cellular network with available unused capacity.

15. The method of claim 14, further comprising configuring the MAC to run as a software development kit (SDK).

16. The method of claim 14, further comprising configuring the MAC to run as a background module on the mobile device.

17. The method of claim 14, further comprising configuring a portal interface to allow an advertiser to sponsor one or more advertisements on the one or more networks.

18. The method of claim 14, further comprising configuring a network capacity forecast module to determine network capacity from crowd-sourced radio frequency data.

19. The method of claim 14, further comprising configuring MAG to cache the web content or advertisements in order to distribute to the mobile device through the MAC upon receipt of a notification of available unused network capacity from the network capacity forecast module.

20. The method of claim 14, further comprising connecting the MAC and MAG via a single connection comprising one or more of a VPN and http tunnel.

21. The method of claim 14, further comprising configuring, of one or more MAGs, the MAG closest to the mobile device to download, cache, and distribute the web content or advertisements to the mobile device.

22. The method of claim 14, further comprising configuring the MAG to schedule a download of the web content or advertisements based on one or more of a preconfigured campaign, a rating of the web content or advertisements, and popularity of the web content or advertisements.
